(19) United States
(12) Patent Application Publication
(10) Pub. No.: US 2022/0226813 A1
(43) Pub. Date: Jul. 21, 2022

(54) MICROFLUIDIC CHIP AND MANUFACTURING METHOD THEREFOR

(71) Applicant: LEADWAY (HK) LIMITED, Sheung Wan ,Hong Kong (CN)

(72) Inventors: Xin ZHANG, Hangzhou, Zhejiang (CN); Yi WANG, Hangzhou, Zhejiang (CN); Li ZHANG, Hangzhou, Zhejiang (CN)

(73) Assignee: LEADWAY (HK) LIMITED, Sheung Wan ,Hong Kong (CN)

(21) Appl. No.: 17/617,284

(22) PCT Filed: Jun. 2, 2020
(86) PCT No.: PCT/CN2020/094011

§ 371 Date: Dec. 7, 2021

(30) Foreign Application Priority Data
Jun. 3, 2019 (CN) 201910478749.X

(51) Int. Cl. B01L 3/00

(52) U.S. Cl. CPC B01L 3/50273; B01L 2200/027; B01L 2200/0689; B01L 2200/12; B01L 2400/0457; B01L 2300/04; B01L 2300/0645; B01L 2300/161; B01L 2200/16

(57) ABSTRACT

Disclosed are a microfluidic chip (1000) and a manufacturing method therefor. The microfluidic chip comprises a substrate (100) and a detection area (2) located on the substrate (100), the substrate (100) is provided with a first liquid storage groove (11) and a second liquid storage groove (12), the first liquid storage groove (11) and the second liquid storage groove (12) are in liquid communication with the detection area (2), the first liquid storage groove (11) is provided with a first opening (51) for liquid to flow out, and the second liquid storage groove (12) is provided with a second opening (52) for liquid to flow out; and when the microfluidic chip (1000) is used for sample detection, along with rotation of the microfluidic chip (1000), a rear end of the liquid flowing out of the first liquid storage groove (11) reaches the detection area (2) earlier than a front end of the liquid flowing out of the second liquid storage groove (12).

### TECHNICAL FIELD

The present invention belongs to the field of medical diagnostic equipment, and relates to a microfluidic chip with a liquid storage function and manufacturing, detection and use methods thereof.

### BACKGROUND ART

In the field of biomedical analysis and disease diagnosis, emergence of the microfluidic technology has promoted development of the portable rapid diagnostic industry. The greatest advantage of the microfluidic detection technology is that it can perform fully automated rapid detection on multiple indicators simultaneously and obtain accurate results under the consumption of a sample in a microliter level. A microfluidic chip can include all functional units in a conventional laboratory such as calibration, quantitative injection, reagent storage, detection and waste liquid collection units.

Fluid control is the core of design of the microfluidic chip. Classified according to fluid power, the fluid power of a microfluidic chip can come from an air pump (e.g., U.S. Pat. No. 8,986,527B2), a syringe (e.g., U.S. Pat. No. 7,842,234), external force extrusion (e.g., U.S. Pat. No. 5,821,399A), and a centrifugal force (e.g., US20110124128A1).

When a chip taking an air pump as power controls more than two fluids, the air pump requires more complex chip micro-channel network design and design of more valves to achieve sequential flow control of the fluids. This leads to characteristics of the instrument that the volume is often large, the requirement for chip processing is high and the cost is high. Taking the air pump as power will also increase the probability of generation of bubbles in the fluid, and the generated bubbles may hinder normal operation of sensors.

A chip taking a syringe as power requires sealed abutment of the syringe and a sample adding port of the chip in terms of operation, which is prone to introducing personal errors, resulting the risk of polluting samples or instruments.

A chip taking external force extrusion as power requires a relatively small size of the chip as the force itself generated by extrusion deformation is relatively small, and this “minitype” change will directly result in the difficulty of chip processing and assembling, causing economic loss.

For a chip taking a centrifugal force as driving force, in principle, the chip driven by the centrifugal force can achieve high-integrated detection to the greatest extent and achieve advantages of sample purification and equivalent sampling in the chip. However, due to its relatively more complex and finer structure, surface tension of the material can affect the flow rate to a great extent, which results in relatively high technical barrier and leads to difficulty in industrialization.

With sharp increase of market demands for in vitro diagnostics, the advantages of the microfluidic technology in the application of in vitro diagnostics have gradually emerged, which attracts more and more attention from the industry. In applications of the microfluidic chips, the sequential flow of multiple fluids and the preservation and flow control of the liquids built in a test wafer are technical problems that need to be solved and improved urgently at present.

### SUMMARY OF THE INVENTION

In order to solve the technical problems described, the present invention designs a novel microfluidic chip taking the action of gravity as fluid power.

The present invention provides a microfluidic chip which can control flow under the action of gravity. The microfluidic chip can complete automatic transfer and detection of multiple fluids without additional power equipment such as a micropump, an injection pump, an extrusion device, a centrifugal force device, etc.

The microfluidic detection chip includes a substrate and a detection area located on the substrate, the substrate is provided with a first liquid storage tank and a second liquid storage tank, the first liquid storage tank and a second liquid storage tank are in liquid communication with the detection area respectively, the first liquid storage tank and the second liquid storage tank are provided with a first opening and a second opening respectively for flowing out of a liquid, the liquid flows out of the first opening prior to the second opening under the action of gravity by rotating the microfluidic chip, and the rear end of the liquid in the first liquid storage tank reaches the detection area earlier than the front end of the liquid in the second liquid storage tank.

The first opening reaches a downward position prior to the second opening by rotating the microfluidic chip, so that the liquid in the first liquid storage tank flows out of the first opening under the action of its own gravity earlier than the liquid in the second liquid storage tank flows out of the second opening under the action of its own gravity; and the rear end of the liquid in the first liquid storage tank reaches the detection area earlier than the front end of the liquid in the second liquid storage tank.

The microfluidic chip is rotated, so that the first opening reaches the downward position, and the liquid in the first liquid storage tank flows out of the first opening under the action of gravity and reaches the detection area, and then the microfluidic chip is rotated again, so that the second opening reaches the downward position, and the liquid in the second liquid storage tank flows out of the second opening under the action of gravity and reaches the detection area. In addition, the front end of the liquid in the second liquid storage tank before leaving the detection area does not contact the rear end of the liquid in the first liquid storage tank.

The microfluidic detection chip also includes a waste liquid tank located on the substrate, and the waste liquid tank is in communication with the detection area. When the liquid in the second liquid storage tank flows out of the second opening under the action of gravity and reaches the detection area, the liquid in the first liquid storage tank located in the detection area flows towards the waste liquid tank under the action of gravity.

In a design, when the liquid flows out of the first opening, the position of the first opening is higher than the position of the detection area; and when the liquid flows out of the second opening, the position of the second opening is higher than the position of the detection area.

When the microfluidic chip is used for detection, the microfluidic chip is vertically placed or vertically placed in an instrument, and then is rotated so that the first opening gradually reaches the downward position during the rotation, and the second opening will not go downward during this rotation, and the liquid flows out of the first opening under the action of its own gravity and flows to the detection area. The microfluidic chip is rotated again so that the second opening gradually reaches the downward position during the rotation, and the liquid flows out of the second opening under the action of its own gravity and flows to the detection area; in addition, the liquid from the first liquid storage tank in the detection area flows towards the waste liquid tank under the action of its own gravity. During the two rotations, the rear end of the liquid flowing out of the first opening reaches the detection area prior to the front end of the liquid flowing out of the second opening.

The first and second liquid storage tanks and the waste liquid tank can run through the substrate or not. When the first and second liquid storage tanks and the waste liquid tank do not run through the substrate, the first and second liquid storage tanks and the waste liquid tank are located on the same side of the substrate, or located on two sides of the substrate respectively.

The microfluidic chip also includes a first flow channel connected to the first opening, a second flow channel connected to the second opening, a third flow channel connected to the front end of the detection area, a fourth flow channel connected to the rear end of the detection area, and a fifth flow channel connected to the waste liquid tank, which are disposed on the substrate; the first flow channel and the second flow channel are connected with the third flow channel; and the fourth flow channel is connected with the fifth flow channel

The detection area is provided with a detection flow channel and a signal acquisition channel, and two ends of the detection flow channel are connected to the third flow channel and the fourth flow channel respectively. The detection area includes an electrode sensor internally.

The microfluidic chip also includes a cover plate for covering the substrate, and the cover plate seals the first and second liquid storage tanks and the waste liquid tank located on the substrate, as well as the first, second, third, fourth and fifth flow channels. Before use of the microfluidic chip, the first liquid storage tank, the second liquid storage tank and the waste liquid tank are sealed.

In a preferred solution, a first air vent, a second air vent and a third air vent are disposed in the cover plate respectively corresponding to the first liquid storage tank, the second liquid storage tank and the waste liquid tank. The first, second and third air vents are all sealed or can be opened. More further, the first, second and third air vents are each provided with a sealing member.

Before use of the microfluidic chip, the first liquid storage tank, the second liquid storage tank and the waste liquid tank are sealed; and flow of the liquids in the first liquid storage tank and the second liquid storage tank is controlled by sealing or opening the second and third air vents.

The first storage tank stores a reagent such as a detection reagent or a calibration product, and the second storage tank stores a sample therein.

In the present invention, a microfluidic detection chip is provided, which controls the flow rate of a liquid through the difference in hydrophilicity and hydrophobicity of the flow channels and realizes more accurate detection. That is, the difference in hydrophilicity and hydrophobicity of surfaces of different areas is used to control the flow rate and diffusion of a liquid such as blood in different areas to ensure that the liquid is able to flow to the detection area in sequence to achieve detection under self-gravity. That is, when the liquid is in a circulating flow channel, a hydrophobic flow channel is used to slow down the flow rate of the liquid to avoid generating bubbles due to excessively fast flow rate. When the liquid is in the flow channel for detection, the hydrophilic flow channel is used to spread the liquid to the entire surface of the flow channel to ensure sufficient contact with a detecting instrument.

A microfluidic chip includes a substrate and a detection area located on the substrate, the substrate is provided with a first liquid storage tank, a second liquid storage tank and a waste liquid tank, the substrate is also provided with a flow channel connecting the first liquid storage tank with the detection area, connecting the second liquid storage tank with the detection area, and connecting the detection area with the waste liquid tank, and the hydrophilicity and hydrophobicity of surfaces of different areas of the flow channel are different.

The flow channel includes a first flow channel connected to the first liquid storage tank, a second flow channel connected to the second liquid storage tank, a third flow channel connected to the front end of the detection area, a fourth flow channel connected to the rear end of the detection area, and a fifth flow channel connected to the waste liquid tank; the first flow channel and the second flow channel are connected with the third flow channel; and the fourth flow channel is connected with the fifth flow channel The detection area is provided with a detection flow channel, and two ends of the detection flow channel are connected with the third flow channel and the fourth flow channel respectively.

Further, the first flow channel, the second flow channel and the fifth flow channel are hydrophobic flow channels; and the third and fourth flow channels and the detection flow channel are hydrophilic flow channels.

The microfluidic chip also includes two cover plates covering two sides of the substrate. The substrate is made of a hydrophobic material or subjected to hydrophobic treatment, one cover plate is made of a hydrophobic material or subjected to hydrophobic treatment, and the other cover plate is made of a hydrophilic material or subjected to hydrophilic treatment. The first flow channel, the second flow channel and the fifth flow channel are located on one side of the substrate; and the third and fourth flow channels and the detection flow channels are located on the other side of the substrate. The side of the substrate provided with the first flow channel, the second flow channel and the fifth flow channel is covered with the hydrophobic cover plate; and the side of the substrate provided with the third and fourth flow channels and the detection flow channel is covered with the hydrophilic cover plate.

In one embodiment, the front and back sides of the substrate are provided with a flow channel respectively, and after the upper and lower cover plates with different hydrophilicity and hydrophobicity are water-tightly adhered to the front and back sides of the substrate, the hydrophilicity and hydrophobicity of the flow channels of the substrate will change correspondingly due to the hydrophilicity and hydrophobicity of the cover plates. In such a way, it is easy to manufacture a detection chip having different hydrophilicity and hydrophobicity in different areas.

The microfluidic chip may also connect the flow channels via through holes running through the substrate, the connection between the flow channels through the through holes can prevent backflow of the liquid, so as to ensure one-way flow of the liquid towards one direction. The first flow channel and the second flow channel are connected with the third flow channel via through holes, and the fourth flow channel and the fifth flow channel are also connected through a through hole. The first flow channel and the second flow channel are respectively connected with the third flow channel through two different through holes.

According to the microfluidic chip described in the present invention, different flow channels at the upstream are respectively connected to the same flow channel at the downstream through separate through holes, and such a design of connection via multiple through holes can prevent the probability of failure when the subsequent incoming liquid passes through the detection flow channel (the same channel), and reinforce the fluid controllability, for example, it can reduce the generation of bubbles, etc.

Further, the first through hole connects the first flow channel and the third flow channel, and the second through hole connects the second flow channel and the third flow channel The first through hole and the second through hole have a certain distance. For example, the distance between the first through hole and the second through hole is greater than 2 mm

In some implementations, along the liquid flow direction, the first through hole is located downstream of the second through hole, and the hole diameter of the first through hole located downstream is smaller than the hole diameter of the second through hole located upstream of the first through hole. On the other hand, the present invention provides a method of manufacturing a microfluidic chip, including the following steps:

step 1: a hydrophobic material is selected as a substrate, and flow channels, a first liquid storage tank, a second liquid storage tank, a detection flow channel, a signal acquisition channel, a waste liquid tank, through holes and other structures are formed on the substrate by chemical etching, physical engraving, hot pressing or injection molding; specifically, the first liquid storage tank, the second liquid storage tank, the detection flow channel and the first, second and third through holes are formed on the substrate; the third flow channel connected to the front end of the detection flow channel and the fourth flow channel connected to the rear end of the detection flow channel are formed on one side of the substrate; the first, second and fifth flow channels and the waste liquid tank are formed on the other side of the substrate, wherein the first flow channel connects the first liquid storage tank and the first through hole, the first through hole connects the first flow channel and the third flow channel, the second flow channel connects the second liquid storage tank and the second through hole, the second through hole connects the third flow channel at the same time, the fourth flow channel and the fifth flow channel are connected through the third through hole, and the tail end of the fifth flow channel is connected to the waste liquid tank;

step 2: an electrode sensor is obtained and is adhered at the detection flow channel to allow the electrode of the sensor to be located in the detection flow channel, and water-tightly seal the surface of the detection flow channel. In the meantime, electrode pins of the sensor are located in the signal acquisition channel of the detection area;

step 3: a cover plate made of a hydrophobic material is obtained; or the side of the cover plate contacting the substrate is treated with a hydrophobic material, i.e., provided with a hydrophobic coating, so that the contact surface of the cover plate is hydrophobic; and the hydrophobic side of the cover plate is water-tightly adhered to the side of the substrate provided with the first, second and fifth flow channels;

step 4: a calibration solution as a detection reagent is injected into the first liquid storage tank;

step 5: a cover plate made of a hydrophilic material is obtained; or the side of the cover plate contacting the substrate is treated with a hydrophilic material, i.e., provided with a hydrophilic coating, so that the contact surface of the cover plate is hydrophilic; and the hydrophilic side of the cover plate is water-tightly adhered to the side of the substrate provided with the third and fourth flow channels;

step 6: first, second and third air vents are disposed on the cover plate at the first and second liquid storage tanks and the waste liquid tank;

step 7: in the absence of step 4, a detection reagent is injected into the first liquid storage tank through the first air vent on the upper cover plate, and then a small hole is sealed by a sealing member.

A microfluidic detection chip that can be used for detection is finally obtained through the method including steps 1-7.

The present invention also provides a method for detecting a sample using a microfluidic chip, which includes a microfluidic chip for detection. The microfluidic chip includes a substrate and a cover plate, and a detection area, a first liquid storage tank, a second liquid storage tank and a waste liquid tank which are located on the substrate, the first liquid storage tank and the second liquid storage tank are in communication with the detection area respectively, and the detection area is in communication with the waste liquid tank; the first liquid storage tank and the second liquid storage tank are provided with a first opening and a second opening respectively for flowing out of a liquid; and the first liquid storage tank includes a detection reagent.

The specific steps are as follows:

step 1, a sample is injected into the second liquid storage tank;

step 2, the microfluidic detection chip is vertically placed or vertically placed in an instrument;

step 3, the first liquid storage tank and the waste liquid tank are caused to be in communication with atmosphere;

step 4, the microfluidic detection chip is rotated until the first opening is downward, so the detection reagent in the first liquid storage tank flows out of the first opening under the action of its own gravity and flows into the detection area;

step 5, reagent detection is performed;

step 6, the microfluidic detection chip is rotated until the second opening is downward, so the sample in the second liquid storage tank flows out of the second opening under the action of its own gravity and flows into the detection area, and meanwhile, the detection reagent located in the detection area flows into the waste liquid tank under the action of its own gravity; and

step 7, sample detection is performed to obtain a detection result.

In a more specific implementation, the microfluidic chip also includes an electrode sensor, the detection area is provided with a detection flow channel and a signal acquisition channel, and the electrode sensor is disposed in the detection flow channel and the signal acquisition channel The cover plate is provided with a first air vent at the position of the first liquid storage tank, provided with a second air vent at the position of the second liquid storage tank, and provided with a third air vent at the position of the waste liquid tank. The specific steps are as follows:

step 1, a sample to be detected is injected into the second liquid storage tank through the second air vent on the second liquid storage tank;

step 2, the microfluidic detection chip is vertically fixed in an instrument and controls the fluid flow direction depending on rotation of the chip driven by components in the instrument;

step 3, the first air vent and the third air vent are opened;

step 4, the microfluidic detection chip is rotated until the first opening is downward, so the detection reagent in the first liquid storage tank flows out of the first opening under the action of its own gravity and flows into the detection area;

step 5, reagent detection is performed;

step 6, the microfluidic chip is rotated until the second opening is downward, so the sample in the second liquid storage tank flows out of the second opening under the action of its own gravity and flows into the detection area, and meanwhile, the detection reagent located in the detection area flows into the waste liquid tank under the action of its own gravity; and

step 7, sample detection is performed to obtain a detection result.

In step 5 and step 7, the detection reagent and sample staying in the detection flow channel react with the sensor, and a probe of the instrument is connected with the sensor in the signal acquisition channel and acquires reaction signals.

In some preferred implementations, the method also includes a first flow channel connected to the first opening, a second flow channel connected to the second opening, a third flow channel connected to the front end of the detection area, a fourth flow channel connected to the rear end of the detection area, and a fifth flow channel connected to the waste liquid tank; the first flow channel and the second flow channel are connected with the third flow channel; and the fourth flow channel is connected with the fifth flow channel.

In step 4, the detection reagent in the first liquid storage tank flows out of the first opening, and flows to the third flow channel through the first flow channel to reach the detection flow channel. In step 6, the sample in the second liquid storage tank flows out of the second opening, and flows to the third flow channel through the second flow channel to reach the detection flow channel

In step 6, the detection reagent after completed detection reaches the waste liquid tank from the detection flow channel via the fourth flow channel and the fifth flow channel In some preferred implementations, the first flow channel, the second flow channel and the fifth flow channel are located on one side of the substrate, and the third and fourth flow channels and the detection flow channel are located on the other side of the substrate. The first flow channel and the third flow channel are connected through the first through hole, the second flow channel is connected with the third flow channel through the second through hole, and the fourth flow channel is connected with the fifth flow channel through the third through hole. In step 4, the detection reagent in the first liquid storage tank flows out of the first opening, flows to the third flow channel on the other side of the substrate through the first flow channel via the first through hole, and reaches the detection flow channel. In step 6, the sample in the second liquid storage tank flows out of the second opening, flows to the third flow channel on the other side of the substrate through the second flow channel via the second through hole, and reaches the detection flow channel. The detection reagent after completed detection flows to the fifth flow channel on the other side of the substrate from the detection flow channel through the fourth flow channel via the third through hole, and reaches the waste liquid tank.

Beneficial Effects

(1) The microfluidic detection chip described in the present invention is used to complete the automatic transfer of multiple fluids in the microfluidic chip by ingeniously utilizing the principle of gravity in terms of fluid driving. Additional power equipment such as a micro pump, a syringe pump, an extrusion device and a centrifugal force device are reduced and even not required. This simplifies the structure of the detection instrument, saves energy, and avoids the generation of bubbles in the fluid due to the use of an external power source.

(2) The difference in hydrophilicity and hydrophobicity of surfaces of different areas in the microfluidic chip is used to control the flow rate and diffusion of a liquid sample in different areas. For example, when the flow rate of a blood sample flowing out of the second liquid storage tank in the hydrophobic second flow channel is slower than the flow rate of the blood sample in the hydrophilic detection flow channel. The detection flow channel is subjected to the hydrophilic treatment, it can assist diffusion of the fluid at multiple detection sites, which avoids the generation of bubbles.

(3) The front and back sides of the substrate of the microfluidic chip are provided with a flow channel respectively, and after the upper and lower cover plates with different hydrophilicity and hydrophobicity are water-tightly adhered to the front and back sides of the substrate, the hydrophilicity and hydrophobicity of the flow channels of the substrate will change correspondingly due to the hydrophilicity and hydrophobicity of the cover plates. In such a way, it is easy to manufacture a detection chip having different hydrophilicity and hydrophobicity in different areas.

(4) In the same channel, the design of connection via multiple through holes can prevent the probability of failure when the subsequent incoming liquid passes through the detection flow channel (the same channel), and reinforce the fluid controllability, for example, it can reduce the generation of bubbles, etc.

### BRIEF DESCRIPTION OF THE DRAWINGS

FIG. 1 a three-dimensional diagram of a first microfluidic detection chip.

FIG. 2 is a front view of FIG. 1, in which the solid line indicates that the structure is on the front side of the substrate, and the dashed line indicates that the structure is on the back side of the substrate.

FIG. 2-1 is a schematic diagram of FIG. 2 after rotating at another angle.

FIG. 3 is an exploded view of FIG. 1, showing the front side of the substrate.

FIG. 4 is an exploded view of FIG. 1, showing the back side of the substrate.

FIG. 5 is a schematic view of the front side of the substrate in FIG. 1.

FIG. 6 is a schematic view of the back side of the substrate in FIG. 1.

FIG. 7-1 to FIG. 7-4 are schematic diagrams showing the process of fluid flow of a microfluidic detection chip.

FIG. 8-1 to FIG. 8-6 are schematic diagrams showing the process of fluid flow of another microfluidic detection chip.

FIG. 9 is a schematic diagram of a microfluidic detection chip with four liquid storage tanks.

FIG. 10 is a schematic diagram of a substrate provided with two fluid control systems.

FIG. 11-A is a schematic diagram showing that a first flow channel and a second flow channel are located on the same plane as a third flow channel and the liquid in the first flow channel is gradually flowing into the third flow channel.

FIG. 11-B is a schematic diagram showing that the liquid in the first flow channel flows into the third flow channel

FIG. 11-C is a schematic diagram showing that the liquid in the second flow channel is flowing.

### DETAILED DESCRIPTION OF THE EMBODIMENTS

In the following detailed description, the reference text attached to legends is a part here, which is described by way of exemplifying particularly specific solutions that the present invention may implement. We do not exclude that the present invention can also implement other specific solutions and change the structure of the present invention without departing from the use scope of the present invention.

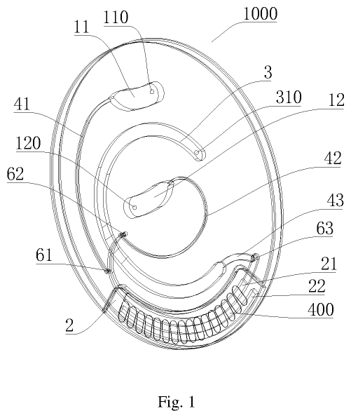

The microfluidic detection chip 1000 as shown in FIGS. 1 to 6 includes a substrate 100, an upper cover plate 200, a lower cover plate 300 and an electrode sensor 400. The substrate 100 is provided with a first liquid storage tank 11, a second liquid storage tank 12, a detection area 2 and a waste liquid tank 3, and the electrode sensor 400 is disposed in the detection area 2. In some embodiments, the microfluidic detection chip is made of a transparent material, and specifically, it may also be that only the upper cover plate and the lower cover plate are made of a transparent material.

The liquid storage tanks, the detection area and the waste liquid tank are communicated through flow channels, so as to form a complete flow path that a reagent and a sample to be detected sequentially flow out of the liquid storage tanks, flow through the detection area and are stored in the waste liquid tank. The upper cover plate 200 and the lower cover plate 300 are water-tightly adhered to the front and back sides of the substrate respectively, so that the liquid storage tanks, the waste liquid tank and the flow channels are sealed in the substrate.

In the present invention, through different positions and directions of openings on the chip through which the liquids in the first liquid storage tank 11 and the second liquid storage tank 12 flow out, and through gravity of the liquids themselves, liquids in the first liquid storage tank 11 and the second liquid storage tank 12 flow into the detection area 2 in sequence, and the detection function of this chip is achieved. Specifically, the opening direction of the first liquid storage tank is caused to be downward, so that the liquid in the first liquid storage tank flows out of the first liquid storage tank under the action of its own gravity, and continues flowing into the detection area under the action of gravity. The opening direction of the second liquid storage tank is also caused to be downward, so that the liquid in the second liquid storage tank flows out of the second liquid storage tank under the action of its own gravity, and continues flowing into the detection area under the action of gravity.

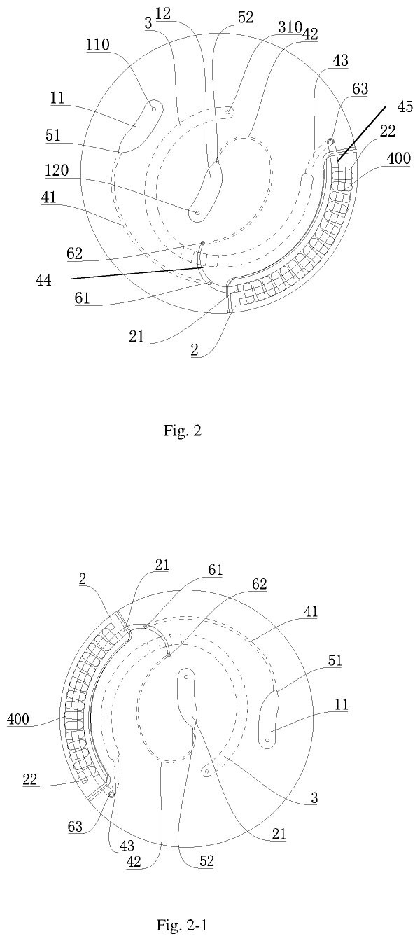

As shown in FIGS. 1 and 2, the opening direction of the first opening 51 connecting the first liquid storage tank 11 and the first flow channel 41 is opposite to the opening direction of the second opening 52 connecting the second liquid storage tank 12 and the second flow channel 42, and at this time, the first liquid storage tank and the second liquid storage tank are substantially parallel. For example, the opening direction of the first opening is leftward, and the opening direction of the second opening is rightward. As shown in FIG. 2, when the chip is in a vertically placed position, the opening of the first opening 51 is downward, the liquid in the first liquid storage tank 11 can flow out of the first opening, the opening of the second opening 52 is downward, and the liquid in the second liquid storage tank 12 cannot flow out of the second opening. When the chip is rotated to the position as shown in FIG. 2-1, the opening of the second opening 52 is downward, and the liquid in the second liquid storage tank 12 flows out of the second opening. The liquids stored in the first liquid storage tank and the second liquid storage tank in the chip sequentially flow out along with rotation of the chip, and sequentially enter the detection flow channel through flow channels to contact the electrode sensor, which is used to obtain analysis signals.

As shown in FIGS. 1 to 6, the material of the substrate 100 is a hydrophobic material, or the surface of the substrate is subjected to hydrophobic treatment, or the surface of the substrate in contact with the liquid is subjected to hydrophobic treatment. The side of the upper cover plate 200 in contact with the substrate 100 is a hydrophilic material, or the surface is treated with a hydrophilic material. The side of the lower cover plate 300 in contact with the substrate 100 is a hydrophobic material, or the surface is subjected to hydrophobic treatment. The hydrophobic material can be made of any one or two of the following mixed materials, such as silicon, ceramics, glass and plastics, wherein the plastics is selected from acrylonitrile-butadiene-styrene copolymer (ABS), cycloalkenyl polymer (COP), polyamide (PA), polybutylene terephthalate (PBT), polycarbonate (PC), polydimethylsiloxane (PDMS), polyethylene (PE), polyvinyl ketone (PEEK), polyethylene terephthalate (PET), polymethyl methacrylate (PMMA), polyoxymethylene (POM), polypropylene (PP), polystyrene diethyl ether (PPE), polystyrene (PS), polysulfone (PSU), polytetrafluoroethylene (PTFE), etc. The hydrophilic material may be a material which finally exhibits hydrophilic performance by treating the surface of the hydrophobic material to have hydrophilic groups, such as by plasma treatment or a hydrophilic coating. The material with hydrophilcity can also be directly selected, for example, a hydrophilic substance is added to the raw material during injection molding.

The detection area 2 is provided with a detection flow channel 21 and a signal acquisition channel 22, which pass through the front and back sides of the substrate. The entire electrode sensor is adhered to the detection area on the back side of the substrate, so that the detection area on the back side of the substrate is sealed up, and the detection site of the electrode sensor is exposed in the detection flow channel 21, and the electrode pins of the sensor are exposed in the signal acquisition channel 22. The third flow channel 44 and the fourth flow channel 45 are connected to the front and rear ends of the detection flow channel respectively, and are located on the front side of the substrate together. The first flow channel 41, the second flow channel 42, the fifth flow channel 43 and the waste liquid tank 3 are disposed on the back side of the substrate. After the hydrophobic lower cover plate is water-tightly adhered to the back side of the substrate, the first flow channel, the second flow channel, the fifth flow channel and the waste liquid tank form a closed pipeline or cavity, and the surface of the formed pipeline and cavity is a hydrophobic surface. When the upper cover plate with a hydrophilic surface is water-tightly adhered to the front side of the substrate, the third flow channel, the fourth flow channel and the detection flow channel form a closed pipeline. At this time, the hydrophobicity of the detection flow channel pipeline is weaker than that of the pipeline formed by the first flow channel, the second flow channel and the fifth flow channel to which the lower cover plate is adhered. The difference in hydrophilicity and hydrophobicity of surfaces of different areas is used to control the flow rate of a liquid such as blood in different areas and adjust the diffusion performance of the fluid.

When the upper cover plate with a hydrophilic surface is water-tightly adhered to the front side of the substrate, the blood sample flows in the detection flow channel and comes into contact with the hydrophilic surface, which effectively adjusts the diffusion performance of the fluid in this area. For example, under the hydrophilic interaction, the blood sample is more conducive to completely covering the electrode area of the sensor in the flow channel during the fluid flow, and even if there are a plurality of detection sites with different surface tensions in the channel, the blood also can diffuse more sufficiently, thus avoiding the generation of bubbles and ensuring the accuracy of detection. If the detection flow channel is completely hydrophobic, when the blood sample flows in this flow channel, some areas of the sensor electrode may have different surface tensions and thus be bypassed by the blood to form bubbles, which affects the accuracy of detection.

The first flow channel, the second flow channel and the fifth flow channel have strong hydrophobicity (relative to the hydrophobicity of the detection flow channel). Through the hydrophobic treatment, the diffusion performance of a fluid in the areas such as the first flow channel, the second flow channel and the third flow channel is adjusted, for example, in these areas, the diffusion rate of the fluid becomes slow, which prevents the generation of bubbles during the flow.

The first flow channel 41 and the second flow channel 42 of the microfluidic detection chip on the back side of the substrate 100 are respectively connected to the third flow channel 44 on the front side of the substrate via through holes.

In one solution, the first flow channel and the second flow channel are in communication with the third flow channel 44 by sharing one through hole. However, due to small hole diameters of the flow channels, if there is only one through hole, the liquid in the first liquid storage tank that flows through the through hole first will form a liquid film on the wall of the through hole, which may affect the controllability of subsequent liquid (such as liquid in the second liquid storage tank) when the liquid flows through the through hole, for example, the through hole generates a hydrophilic effect after the first fluid infiltration, and loses the ability to control the flow rate of the fluid, so that it is very easy to generate bubbles. It is also possible that the liquid in the first liquid storage tank that flows through the through hole first forms a liquid film at the through hole and blocks the through hole, which prevents the liquid in the second liquid storage tank from flowing past the through hole to reach the detection area.

In the solutions as shown in FIGS. 1 to 6, the first flow channel and the second flow channel are in communication with the detection flow channel but do not share one through hole. Specifically, one end of the first flow channel 41 disposed on the back side of the substrate 100 is in communication with the first liquid storage tank 11, and the other end is communication with the third flow channel 44 in the detection area on the front side of the substrate through the first through hole 61 on the substrate. One end of the second flow channel 42 disposed on the back side of the substrate is in communication with the second liquid storage tank 12, and the other end is communication with the third flow channel 44 in the detection area on the front side of the substrate through the second through hole 62 on the substrate. The fourth flow channel 45 is in communication with the waste liquid tank 3 through the third through hole 63 and the fifth flow channel 43.

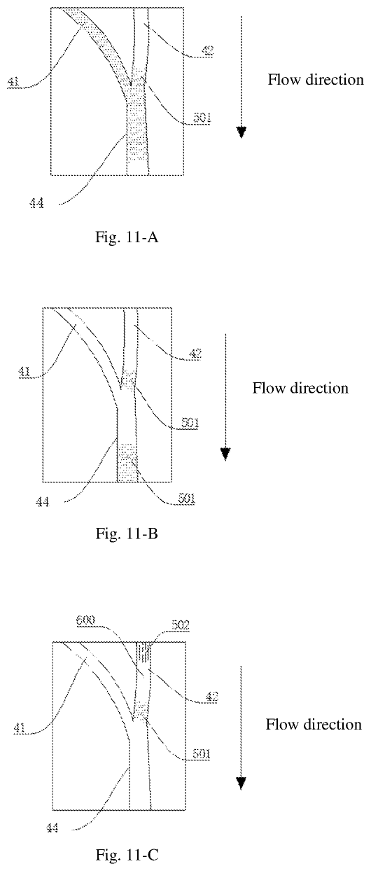

The first flow channel and the second flow channel are located on the same plane, but are not on the same plane as the third flow channel and the detection flow channel, and the first flow channel and the second flow channel are connected with the third flow channel respectively through their respective through holes. Compared with the fact that the first flow channel, the second flow channel and the third flow channel are disposed on the same plane (as shown in FIGS. 11-A to 11-C), this design has at least the following effect: it can reduce the probability of failure when the subsequent incoming liquid passes through the detection flow channel Even if the liquid in the first liquid storage tank forms a liquid film at the first through hole and blocks the first through hole, it will not affect the liquid in the second liquid storage tank to flow into the detection flow channel through the second through hole. The fluid controllability is enhanced, and the generation of bubbles is reduced.

As shown in FIGS. 11-A and 11-B, the first flow channel, the second flow channel and the detection flow channel are disposed on the same plane. As shown in FIG. 11-A, when the first liquid 501 in the first flow channel is first allowed to flow into the third flow channel 44, a little of the first liquid will enter the second flow channel 42. As shown in FIG. 11-B, after the first liquid completely flows into the third flow channel 44, the first liquid 501 that has previously entered the second flow channel will retain in the second flow channel. As shown in FIG. 11-C, when the second liquid 502 enters the second flow channel, there will be a segment of air column 600 between the second liquid and the first liquid retained in the second flow channel. Since the flow of the liquid in the chip does not depend on an additional power source, the presence of this segment of air column will prevent the second liquid from continuing flowing into the third flow channel 44, which ultimately results in that the second fluid cannot reach the detection flow channel through the third flow channel 44 to complete the detection.

In a preferred design, there's a certain distance between the first through hole and the second through hole, for example, the distance between the two is greater than 2 mm This ensures that when the liquid in the first storage tank flows past the detection flow channel, the liquid will not flow to the second through hole in the opposite direction. In one design, based on the fact that the first flow channel and the second flow channel are located on the same plane and are not on the same plane as the third flow channel and the detection flow channel, the first flow channel and the second flow channel are connected with the third flow channel respectively through the first through hole and the second flow channel, and the liquid in the first flow channel first flows into the third flow channel and the detection flow channel through the first through hole. In an optimized design, the first through hole is located downstream of the second through hole (liquid flow direction), and the hole diameter of the first through hole located downstream is smaller than the hole diameter of the second through hole located upstream of the first through hole, and when the second liquid flows through the first through hole, a liquid film is formed at the through hole as the first hole diameter is small. On the one hand, this design prevents the second liquid from flowing out of the third flow channel from the first through hole to enter the first flow channel. On the other hand, the second through hole has a large opening, which can accelerate the speed that the second liquid flows into the third flow channel and speed up the detection process.

In some embodiments, the first flow channel and the second flow channel on the substrate have an opening width of 0.2-0.8 mm and a depth of 0.2-0.6 mm, and the waste liquid tank has an opening width of 0.2-3 mm More specifically, the substrate has a thickness of 0.4 to 5 mm, the first flow channel and the second flow channel on the substrate have an opening width of 0.4 mm and a depth of 0.3 mm, and the waste liquid tank has an opening width of 1.5 mm and a depth of 0.2-0.6 mm The microfluidic detection chip described in the present invention can be used to complete the automatic transfer of multiple fluids without additional power equipment in terms of fluid driving.

In some designs, the flow channel may not run through the substrate. In some other design solutions, the flow channel may run through the substrate.

The microfluidic detection chip as shown in FIG. 7-1 to FIG. 7-4 includes a substrate, an upper cover plate, a lower cover plate and an electrode sensor. The substrate 100 is provided with a first liquid storage tank 11, a second liquid storage tank 12, a detection area 2 and a waste liquid tank 3, and the electrode sensor is disposed in the detection area 2. The liquid storage tanks, the detection area and the waste liquid tank are in communication through flow channels, and the upper cover plate and the lower cover plate are water-tightly adhered to the front and back sides of the substrate respectively, so that the liquid storage tanks, the waste liquid tank, the flow channels and the like are sealed in the substrate. The substrate is made of a hydrophobic material, the surface of the upper cover plate attached to the substrate is made of a hydrophilic material, and the surface of the lower cover plate attached to the substrate is made of a hydrophobic material. The opening direction of the first opening 51 connecting the first liquid storage tank 11 and the first flow channel 41 is opposite to the opening direction of the second opening 52 connecting the second liquid storage tank 12 and the second flow channel 42. Specifically, when the direction of the first opening is downward, the direction of the second opening is upward or obliquely upward. More specifically, when the direction of the first opening is downward, the angle that the direction of the second opening is obliquely upward is vertically upward and between plus or minus 30 degrees thereof.

In this embodiment, the upper cover plate is provided with a first air vent 110 at the position of the first liquid storage tank, provided with a second air vent 120 at the position of the second liquid storage tank, and provided with a third air vent 310 at the position of the waste liquid tank. Moreover, the air vent holes are sealed with sealing members. After the sealing members are removed, the detection reagent in the first liquid storage tank is injected into the first liquid storage tank through the first vent hole, and the detection sample is injected into the second liquid storage tank through the second air vent. During the detection operation, gas in a pipeline is removed from the chip through the third air vent.

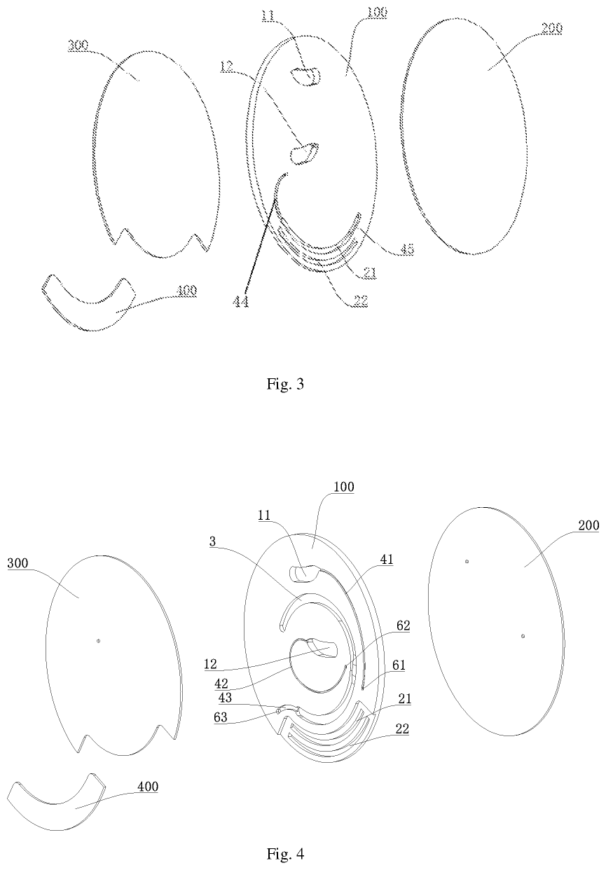

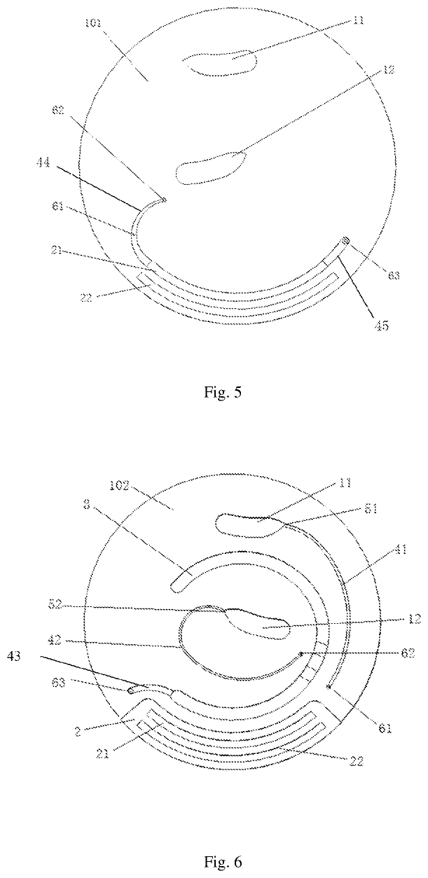

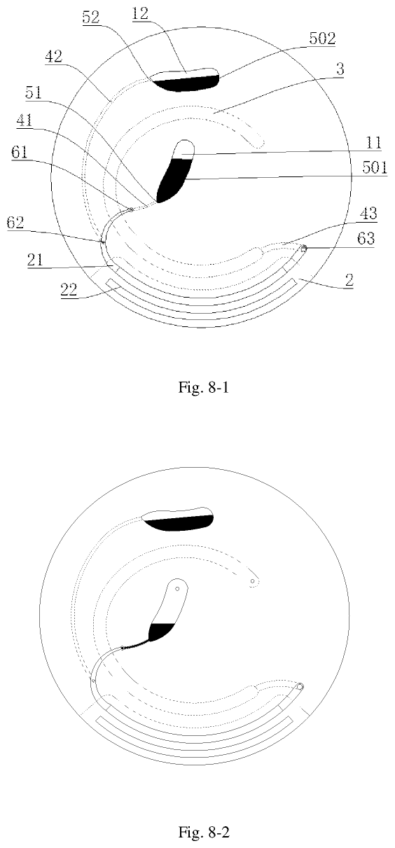

The specific operation is as shown in FIG. 7-1 to FIG. 7-4. The first liquid storage tank 11 is used to store a detection reagent 501, such as a calibration solution, and the second liquid storage tank 12 is used to store a sample to be detected 502, such as a blood sample. The operating chip is vertically fixed in the instrument and controls the fluid flow direction depending on rotation of the chip driven by components in the instrument, so as to achieve the purpose of sequentially transferring the detection reagent and the sample to be detected to the detection flow channel When the chip is in the position in FIG. 7-1, the opening direction of the first opening 51 connecting the first liquid storage tank 11 and the first flow channel 41 is downward, so that the detection reagent 501 in the first liquid storage tank flows into the first flow channel 41 under the action of its own gravity and the capillary force provided by the first flow channel 41. At the same time, the opening direction of the second opening 52 connecting the second liquid storage tank 12 and the second flow channel 42 is obliquely upward, and the liquid 502 in the second liquid storage tank cannot flow out of the second opening 52. When the chip is rotated from the position in FIG. 7-1 to the position in FIG. 7-2, the detection reagent in the first flow channel 41 flows from the back side of the substrate towards the third flow channel 44 and the detection flow channel 21 located on the front side of the substrate via the first through hole 61, the detection reagent staying in the detection flow channel 21 reacts with the sensor, and the probe of the instrument is connected to the pins of the sensor in the signal acquisition channel 22 and collects the reaction signal. In the position in FIG. 7-2, since the liquid in the first storage tank flows out to enter the detection flow channel prior to the liquid in the second storage tank, at this time, an air column is formed between the sample to be detected in the second storage tank 12 and the detection reagent in the detection flow channel, and the sample to be detected stored in the second liquid storage tank is subjected to unequal air pressure, so it will retain in the second liquid storage tank 12. After the detection of the detection reagent is completed, the chip is rotated to the position in FIG. 7-3, and the detection reagent in the detection flow channel 21 flows into the fifth flow channel 43 on the back side of the substrate through the fourth flow channel 45 and the third through hole 63 until it flows into the waste liquid tank 3. During this rotation, the second opening of the second liquid storage tank reaches a position facing downward, and the sample in the second liquid storage tank flows out of the opening to reach the second flow channel 42. In a more preferred embodiment, since the second flow channel 42 includes a segment of elbow, when the chip is in the position in FIG. 7-3, part of the liquid flowing out of the second liquid storage tank will be reserved in the elbow. The chip continues to be rotated to the position in FIG. 7-4, the detection reagent has flowed out of the detection flow channel to enter the waste liquid tank, and the volume of the waste liquid tank is large, so the detection reagent 501 can completely enter the waste tank (there is a third air vent outside), the fluid located in the second liquid storage tank flows out of the liquid storage tank under the action of its own gravity, and flows into the third flow channel 44 and the detection flow channel 21 on the front side of the substrate through the second flow channel 42 and the second through hole 62 on the back side of the substrate, the sample staying in the detection flow channel reacts with the sensor, and at this time, the instrument collects the signal of the sample to be detected through the pins of the sensor.

The microfluidic detection chip and specific operation steps are as shown in FIG. 8-1 to FIG. 8-6. The microfluidic detection chip includes a substrate, an upper cover plate, a lower cover plate and an electrode sensor. The substrate 100 is provided with a first liquid storage tank 11, a second liquid storage tank 12, a detection area 2 and a waste liquid tank 3, and the electrode sensor is disposed in the detection area 2. The liquid storage tanks, the detection area and the waste liquid tank are in communication through flow channels, and the upper cover plate and the lower cover plate are water-tightly adhered to the front and back sides of the substrate respectively, so that the liquid storage tanks, the waste liquid tank, the flow channels and the like are sealed in the substrate. When the liquid in the first liquid storage tank 11 flows out of the first opening 51, the position of the liquid level in the second liquid storage tank is lower than the second opening, so that it will not flow out of the second opening. The first storage tank 11 is used to store the detection reagent 501, such as a calibration solution, a quality control solution, or an enzyme and other reaction reagents. The second storage tank 12 is used to store a sample to be detected 502, such as a blood sample.

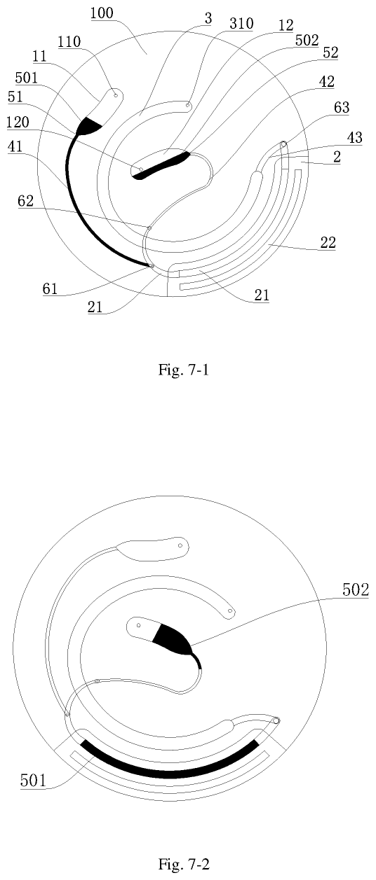

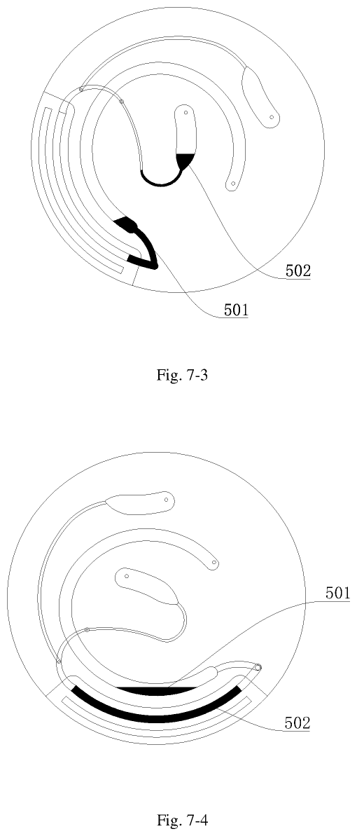

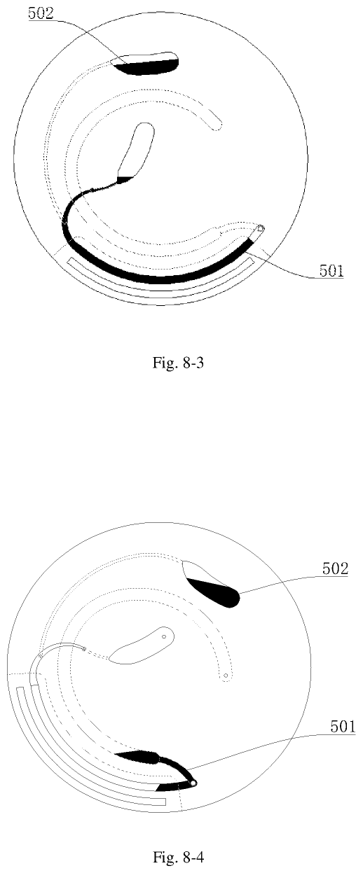

When the chip is in the position in FIG. 8-1 to FIG. 8-3, the liquid level in the second liquid storage tank is lower than the opening of the second opening 52, and the direction of the first opening 51 is downward, so that the liquid in the first liquid storage tank flows into the first flow channel 41 under the action of its own gravity, then flows towards the third flow channel 44 on the front side of the substrate from the back side of the substrate through the first through hole 61, and finally reaches the detection flow channel 21, and within the reserved time, the detection reagent in the detection flow channel reacts with the sensor. The probe of the instrument is connected with pins of the sensor in the signal acquisition channel 22 and acquires the reaction signal. When the detection chip is rotated to the position shown in FIG. 8-4, the detection reagent in the detection flow channel 21 enters the fifth flow channel 43 through the fourth flow channel and the third through hole, and then enters the waste liquid tank 3. At this time, the liquid in the second liquid storage tank continues retaining in the second liquid storage tank. When the detection chip is further rotated to the position shown in FIG. 8-5, the second opening of the second liquid storage tank faces downward and is in the liquid outflow position. The liquid in the second liquid storage tank flows into the second flow channel 42 under the action of its own gravity, and flows into the third flow channel 44 and the detection flow channel 21 on the front side of the substrate through the second through hole 62. The chip continues to be rotated to the position in FIG. 8-6, so that the liquid in the second liquid storage tank completely enters the detection flow channel 21, and the sample staying in the detection flow channel 21 reacts with the sensor. At this time, the instrument collects the signal of the sample to be detected through the pins of the sensor.

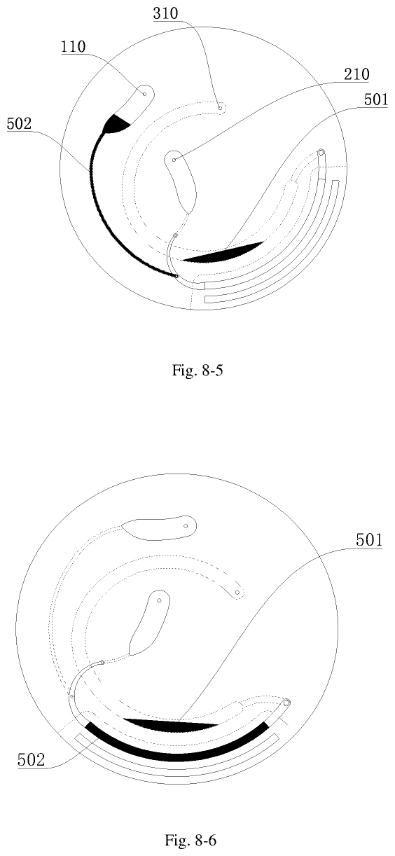

The microfluidic detection chip as shown in FIG. 9 is provided with a first liquid storage tank 11, a second liquid storage tank 12, a third liquid storage tank 13, and a fourth liquid storage tank 14 on the substrate, which are correspondingly connected to the first flow channel to the fourth flow channel (410-440), the first detection flow channel 21 and the second detection flow channel 23, the fifth flow channel 450 and the sixth flow channel 460 located at the front and rear ends of the first detection flow channel, the seventh flow channel 470 and the eighth flow channel 480 located at the front and rear ends of the second detection flow channel, and the first waste liquid tank 31 and the second waste liquid tank 32. The first waste liquid tank 31 is in communication with the sixth flow channel 460 and the first detection flow channel 21 through the ninth flow channel 490 and the through hole 65, and the second waste liquid tank 32 is in communication with the eighth flow channel 480 and the second detection flow channel 23 through the tenth flow channel 491 and the through hole 66. The first liquid storage tank, the first flow channel, the first through hole, the fifth flow channel, the first detection flow channel, the sixth flow channel, the through hole 65, the ninth flow channel and the first waste liquid tank form a flow path. The second liquid storage tank, the second flow channel, the second through hole, the fifth flow channel, the first detection flow channel, the sixth flow channel, the through hole 65, the ninth flow channel and the first waste liquid tank form a flow path. The third liquid storage tank, the third flow channel, the third through hole, the seventh flow channel, the second detection flow channel, the eighth flow channel, the through hole 66, the tenth flow channel 491 and the second waste liquid tank form a flow path. The fourth liquid storage tank, the fourth flow channel, the fourth through hole, the seventh flow channel, the second detection flow channel, the eighth flow channel, the through hole 66, the tenth flow channel 491 and the second waste liquid tank form a flow path. By rotating the chip, the liquids in the liquid storage tanks flow out in sequence under the action of their own gravity and flow in the flow paths.

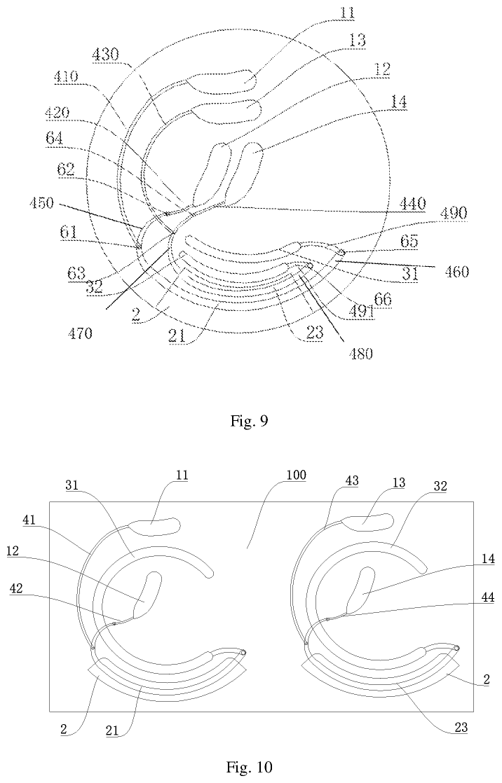

The microfluidic detection chip as shown in FIG. 10 is provided with two fluid control systems on one substrate. The first fluid control system includes a first liquid storage tank 11, a second liquid storage tank 12, a first flow channel 41, a second flow channel 42, a detection flow channel 21 disposed in the reaction zone 2, and a first waste liquid tank 31. The second fluid control system includes a third liquid storage tank 13, a fourth liquid storage tank 14, a third flow channel 43, a fourth flow channel 44, a detection flow channel 23 disposed in the reaction zone 2, and a first waste liquid tank 32.

On the substrate of another microfluidic detection chip, the first liquid storage tank, the second liquid storage tank, the first flow channel, the second flow channel, the detection flow channel, the third flow channel and the waste liquid tank are all disposed on the front side of the substrate, and both the first flow channel and the second flow channel are in communication with the detection flow channel. By rotating the chip, the liquids in the liquid storage tanks flow out in sequence under the action of their own gravity and flow in the flow paths.

Taking the chip in FIGS. 1 to 7 as an example, the manufacturing method of the chip will be described.

Step 1, a hydrophobic material is selected as the substrate, and flow channels, liquid storage tanks, a detection flow channel, a signal acquisition channel, a waste liquid tank, through holes and other structures are formed on the substrate by chemical etching, physical engraving, hot pressing or injection molding.

Step 2: an electrode sensor is obtained and is adhered at the detection flow channel on the lower surface of the substrate to allow the electrode of the sensor to be located in the detection flow channel, and the lower surface of the detection flow channel is water-tightly sealed at the same time. In the meantime, electrode pins of the sensor are located in the signal acquisition channel of the detection area.

Step 3: a hydrophobic lower cover plate is obtained (or the surface of the lower cover plate in contact with the back side of the substrate, which is treated with a hydrophobic material, is hydrophobic); and the lower cover plate is water-tightly adhered to the back side of the substrate.

Step 4: a hydrophilic upper cover plate is obtained (or the surface of the upper cover plate in contact with the front side of the substrate, which is treated with a hydrophilic material, is hydrophilic). The upper cover plate is water-tightly adhered to the front side of the substrate. The detection reagent is injected into the first liquid storage tank through the first air vent of the upper cover plate, and then a small hole is sealed with a sealing member. A microfluidic detection chip that can be used for detection is obtained.

In another embodiment, if the upper cover plate is not provided with the first air vent, in the above step 4, the calibration solution as the detection reagent is injected into the first liquid storage tank, and then the hydrophilic upper cover sheet or the upper cover plate of which the surface in contact with the front side of the substrate is subjected to hydrophilic treatment is water-tightly adhered to the front side of the substrate, thereby sealing the detection reagent in the first liquid storage tank. In the detection procedure, when the liquid in the first liquid storage tank needs to flow out of the first storage tank, a small hole is formed on the upper cover plate above the first storage tank to allow air to enter the first liquid storage tank, but the liquid will not flow out of the first storage tank through the small hole and the chip.

The method for sample detection using the microfluidic chip of the present invention includes the following steps:

Step 1, the microfluidic detection chip described in the present invention is obtained.

Step 2, a blood sample to be detected is injected into the second liquid storage tank through the second air vent on the second liquid storage tank on the upper cover plate.

Step 3, the detection chip is vertically fixed in an instrument and controls the fluid flow direction depending on rotation of the chip driven by components in the instrument. When the chip is in the position in FIG. 7-1, open the first air vent on the first liquid storage tank of the upper cover plate, and open the third vent hole at the same time. The calibration solution in the first liquid storage tank 11 flows into the first flow channel 41. At the same time, the opening direction of the second opening 52 connecting the second liquid storage tank 12 and the second flow channel 42 is obliquely upward, and the liquid 502 in the second liquid storage tank cannot flow out of the second opening.

Step 4, when the chip is rotated from the position in FIG. 7-1 to the position in FIG. 7-2, the detection reagent in the first flow channel 41 flows from the back side of the substrate towards the detection flow channel located on the front side of the substrate through the first through hole 61, the detection reagent staying in the detection flow channel reacts with the sensor, and the probe of the instrument are connected to the pins of the sensor in the signal acquisition channel 22 and acquires the reaction signal.

Step 5, the chip is rotated from the position in FIG. 7-2 to the position in FIG. 7-3, and the detection reagent in the detection flow channel 21 flows into the fifth flow channel 43 on the back side of the substrate through the third through hole 63 until it flows into the waste liquid tank 3.

Step 6, the chip continues to be rotated to the position in 7-4, the detection reagent has flowed out of the detection flow channel to enter the waste liquid tank, and the blood sample to be detected in the second liquid storage tank flows out of the liquid storage tank and flows into the detection flow channel 21 on the front side of the substrate through the second flow channel 42 and the second through hole 62 on the back side of the substrate, the sample staying in the detection flow channel reacts with the sensor, and at this time, the instrument collects the signal of the sample to be detected through the pins of the sensor. Thus, the detection result is obtained.

The detection method in the detection area described in the present invention may be a biosensor with an electrode, or an optical detection method such as turbidimetry, fluorescence method, chemiluminescence method and scattering method, or other detection methods.

The microfluidic detection chip described in the present invention can perform quantitative, semi-quantitative or qualitative detection. For example, one or more test papers (either blank test papers, or test papers with pre-added reagents) are fixed in the detection area. After the detection reagent or sample flows past the detection flow channel to come into contact with the test papers, the reagent reacts with the sample to generate color change, and then the detection result can be obtained through instrument or human observation.

1. A microfluidic chip, comprising a substrate and a detection area located on the substrate, wherein the substrate is provided with a first liquid storage tank and a second liquid storage tank, the first liquid storage tank and the second liquid storage tank are respectively in liquid communication with the detection area, the first liquid storage tank is provided with a first opening for flowing out of a liquid, and the second liquid storage tank is provided with a second opening for flowing out of a liquid; when the microfluidic chip is used for sample detection, the rear end of the liquid flowing out of the first liquid tank reaches the detection area earlier than the front end of the liquid flowing out of the second liquid storage tank.

2. The microfluidic chip according to claim 1, wherein the opening directions of the first opening and the second opening are opposite; or the opening directions of the first opening and the second opening are substantially the same, but when the liquid flows out of the first liquid storage tank, the liquid will not flow out of the second liquid storage tank.

3. The microfluidic chip according to claim 1, further comprising a waste liquid tank, wherein the detection area is in communication with the waste liquid tank.

4. The microfluidic chip according to claim 1, wherein the first liquid storage tank is in communication with the detection area through a first flow channel and a third flow channel, the second liquid storage tank is in communication with the detection area through a second flow channel and a third flow channel, and the detection area is in communication with the waste liquid tank through a fourth flow channel and a fifth flow channel; and the first flow channel, the second flow channel and the fifth flow channel are located on one side of the substrate, and the third flow channel, the fourth flow channel and the detection flow channel are located on the other side of the substrate.

5. The microfluidic chip according to claim 4, wherein the hydrophilicity and hydrophobicity of the first flow channel, the second flow channel and the fifth flow channel are exactly opposite to those of the third flow channel and the fourth flow channel

6. The microfluidic chip according to claim 5, wherein the first flow channel, the second flow channel and the fifth flow channel are hydrophobic flow channels; and the third flow channel, the fourth flow channel and the detection flow channel are hydrophilic flow channels.

7. The microfluidic chip according to claim 1, further comprising an upper cover plate and a lower cover plate which water-tightly cover two sides of the substrate respectively; wherein at least the part of one cover plate in contact with the substrate is hydrophobic, and at least the part of the other cover plate in contact with the substrate is hydrophilic.

8. The microfluidic chip according to claim 4, wherein the first flow channel and the second flow channel are connected with the third flow channel via through holes, and the fourth flow channel is connected with the fifth flow channel through a through hole.

9. The microfluidic chip according to claim 1, wherein the detection area comprises a detection element therein.

10. The microfluidic chip according to claim 9, wherein the detection element is selected from an electrochemical sensor or an optical test paper.

11. A manufacturing method of a microfluidic chip, comprising the following steps:
(1) obtaining a substrate, and forming a first liquid storage tank, a second liquid storage tank, a detection area, a waste liquid tank and flow channels on the substrate;
(2) disposing a detection element in the detection area;
(3) adding a reagent to the first liquid storage tank; and
(4) sealing the first liquid storage tank, the second liquid storage tank, the detection area, the waste liquid tank and the flow channels with a cover plate.

12. The manufacturing method according to claim 11, wherein the first liquid storage tank is in communication with the detection area through a first flow channel and a third flow channel, the second liquid storage tank is in communication with the detection area through a second flow channel and a third flow channel, and the detection area is in communication with the waste liquid tank through a fourth flow channel and a fifth flow channel; and the first flow channel, the second flow channel and the fifth flow channel are located on one side of the substrate, and the third flow channel, the fourth flow channel and the detection flow channel are located on the other side of the substrate.

13. The manufacturing method according to claim 12, wherein the first flow channel is in communication with the third flow channel through a first through hole, and the second flow channel in communication with the third flow channel through a second through hole.

14. The manufacturing method according to claim 12, wherein the first flow channel, the second flow channel and the fifth flow channel are subjected to hydrophobic treatment; and the third flow channel, the fourth flow channel and the detection area are subjected to hydrophilic treatment.

15. The manufacturing method according to claim 12, wherein the cover plate covering the first liquid storage tank, the second liquid storage tank and the waste liquid tank is provided with air vents.
